(19) United States
(12) Patent Application Publication
(10) Pub. No.: US 2026/0303181 A1
(43) Pub. Date: Oct. 1, 2026

(54) PRECODING DESIGN FOR CHANNEL STATE INFORMATION REPORTING

(71) Applicant: ZTE CORPORATION, Shenzhen, Guangdong (CN)

(72) Inventors: Shujuan ZHANG, Shenzhen (CN); Yijian CHEN, Shenzhen (CN); Jun YANG, Shenzhen (CN); Mengnan JIAN, Shenzhen (CN); Hongkang YU, Shenzhen (CN); Feng BI, Shenzhen (CN)

(21) Appl. No.: 19/479,538

(22) PCT Filed: Apr. 28, 2023
(86) PCT No.: PCT/CN2023/091901

§ 371 Date: Oct. 28, 2025

(51) Int. Cl. H04B 7/06

(52) U.S. Cl. CPC H04B 7/0639; H04B 7/0663

(57) ABSTRACT

Methods, apparatus, and systems that relate to channel state information reporting, particularly precoding design and reporting, for extremely large-scale massive multiple-input multiple-output (XL-MIMO) systems are disclosed. In one example aspect, a method for wireless communication includes receiving a reference signal from a transmitting device and determining a precoding matrix based on the reference signal, where a structure of the precoding matrix is based on one or more vectors. The method also includes transmitting information about the precoding matrix to the transmitting device. The precoding matrix represents feedback information for an array of antenna ports of the reference signal. Each element of a vector among the one or more vectors corresponds to one or more antenna ports of the reference signal. The elements in the vector being zero indicates that the reference signal from a sub-set of the array of antenna ports are at least partially invisible to the receiving device.

### CROSS-REFERENCE TO RELATED APPLICATION(S)

The present application is a national phase entry under 35 U.S.C 371 of International Application No. PCT/CN2023/091901, filed on Apr. 28, 2023. The entire contents of the International Patent Application are incorporated herein by reference.

### TECHNICAL FIELD

This patent document is directed to digital communications.

### BACKGROUND

Mobile communication technologies are moving the world toward an increasingly connected and networked society. The rapid growth of mobile communications and advances in technology have led to greater demand for capacity and connectivity. Other aspects, such as energy consumption, device cost, spectral efficiency, and latency are also important to meeting the needs of various communication scenarios. Various techniques, including new ways to provide higher quality of service, longer battery life, and improved performance are being discussed.

### SUMMARY

This patent document describes, among other things, techniques that related to channel state information reporting, particularly precoding design and reporting, for extremely large-scale massive multiple-input multiple-output (XL-MIMO) systems. The disclosed techniques are suitable for scenarios in which signals from part of the antenna ports are not received by the receiving device due to blockage. The disclosed techniques take into account the fact that the distribution of the blocked antenna ports may be different for different paths/scattering paths to ensure that the reported precoding matrix matches the channel with minimal reporting overhead, thereby improving spectrum efficiency and reducing communication latency.

In one example aspect, a method for wireless communication includes receiving, by a receiving device, a reference signal from a transmitting device and determining, by the receiving device, a precoding matrix based on the reference signal, where a structure of the precoding matrix is based on one or more vectors. The method also includes transmitting, by the receiving device, information about the precoding matrix to the transmitting device.

In one example aspect, a method for wireless communication includes transmitting, by a transmitting device, a reference signal to a receiving device; and receiving, by the transmitting device from the receiving device, information about a precoding matrix corresponding to the reference signal, where a structure of the precoding matrix is based on one or more vectors.

In another example aspect, a communication apparatus is disclosed. The apparatus includes a processor that is configured to implement an above-described method.

In yet another example aspect, a computer-program storage medium is disclosed. The computer-program storage medium includes code stored thereon. The code, when executed by a processor, causes the processor to implement a described method.

These, and other, aspects are described in the present document.

### BRIEF DESCRIPTION OF THE DRAWINGS

FIG. 1 illustrates an example model of an XL-MIMO system.

FIG. 2 is a flowchart representation of a method for wireless communication in accordance with one or more embodiments of the present technology.

FIG. 3 is a flowchart representation of another method for wireless communication in accordance with one or more embodiments of the present technology.

FIG. 4 shows an example of a wireless communication system where techniques in accordance with one or more embodiments of the present technology can be applied.

FIG. 5 is a block diagram representation of a portion of a radio station in accordance with one or more embodiments of the present technology can be applied.

### DETAILED DESCRIPTION

Section headings are used in the present document only to improve readability and do not limit scope of the disclosed embodiments and techniques in each section to only that section. Furthermore, some embodiments are described with reference to Third Generation Partnership Project (3GPP) Fifth Generation (5G) New Radio (NR) or Sixth Generation (6G) standard for ease of understanding and the described technology may be implemented in different wireless system that implement protocols other than the NR or 6G protocol.

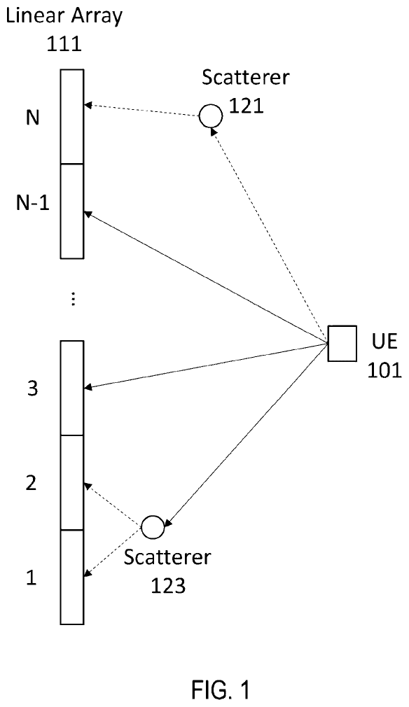

Extremely large-scale massive multiple-input multiple-output (XL-MIMO) is a multi-antenna technology in which a significant number of antennas are widely spread. FIG. 1 illustrates an example model of an XL-MIMO system. In this model, the base station (BS) includes M elements arranged in a linear array 111 (also referred to as array 111 or antenna array 111). XL-MIMO technology can provide seamless mobile communication because users are surrounded by base station (BS) antennas, but the large arrays and the close distance between an array and a user can result in different channel conditions. The signal from a User Equipment (UE) 101 can arrive at the array 111 along the line-of-sight (LOS) path or be reflected by multiple scatterers 121, 123. For a Line of Sight (LOS) path or a Non-LOS (NLOS) path that is scattered by a scattering body, only part of the antenna array 111 can receives the signal transmitted by the UE 101 due to blockage or other electromagnetic phenomena. In addition, the distribution of the part of the antennas array 111 is specific to each path. Different paths may correspond to different distributions of the partial antennas. Similarly, the distribution of the partial antennas is specific to each path for signals transmitted from partial antennas of the array 111 to the UE. Different paths may correspond to different distribution of the partial antennas. As shown in FIG. 1, for a path scattered by scatterer 121, only the signal from antenna sub array N-1 can be received by the UE. For a path scattered by scatterer 123, only the signal from antenna sub array 1 and 2 can be received by the UE. For a LOS path, only the signal from antenna sub array 3 to N-1 can be received by the UE.

Therefore, the channel state information (CSI) reporting for XL-MIMO communication needs to be adapted for XL-MIMO communications. This patent document discloses techniques that can be implemented in various embodiments to determine and indicate precoding matrix considering the above characteristics of the XL-MIMO communications.

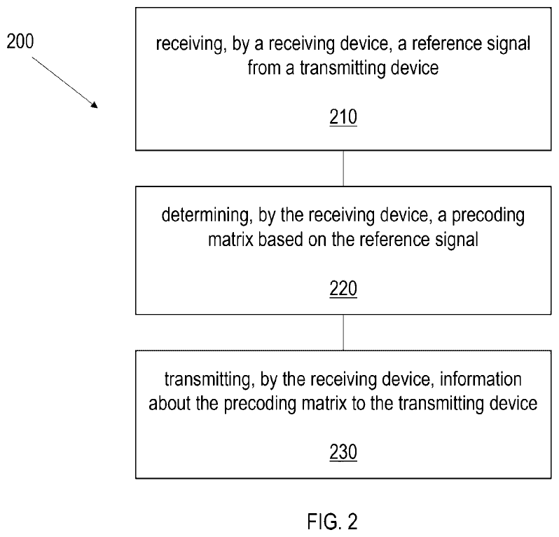

FIG. 2 is a flowchart representation of a method for wireless communication in accordance with one or more embodiments of the present technology. The method 200 includes, at operation 210, receiving, by a receiving device, a reference signal from a transmitting device. The method 200 includes at operation 220, determining, by the receiving device, a precoding matrix based on the reference signal. A structure of the precoding matrix is determined based on one or more vectors (e.g., spatial domain vectors) that correspond to the antenna elements. The method also includes, at operation 230, transmitting, by the receiving device, information about the precoding matrix to the transmitting device.

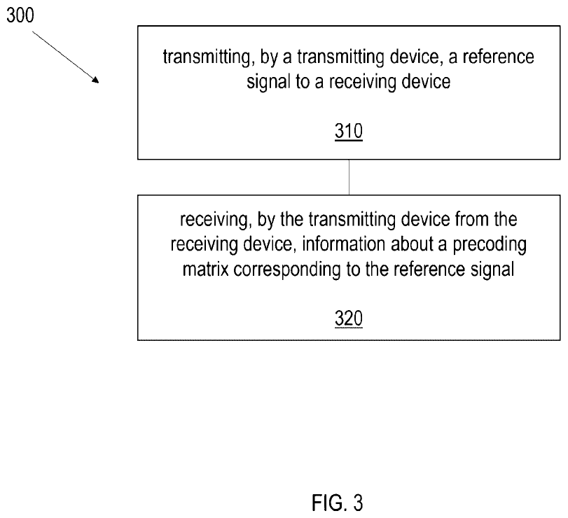

FIG. 3 is a flowchart representation of a method for wireless communication in accordance with one or more embodiments of the present technology. The method 300 includes, at operation 310, transmitting, by a transmitting device, a reference signal to a receiving device. The method also includes, at operation 320, receiving, by the transmitting device from the receiving device, information about a precoding matrix corresponding to the reference signal. A structure of the precoding matrix is based on one or more vectors (e.g., spatial domain vectors) that correspond to the antenna elements.

In some embodiments, the precoding matrix represents feedback information for an array of antenna ports of the reference signal. Each element of a vector among the one or more vectors corresponds to one or more antenna ports of the reference signal. The one or more elements in the vector being zero indicates that the reference signal from a sub-set of the array of antenna ports are at least partially invisible to the receiving device. In some embodiments, the reference signal from the sub-set of the array of antenna ports corresponds to the vector and the sub-set includes antenna ports of the reference signal corresponds to the one or more elements in the vector.

In some embodiments, one or more elements in a vector of the one or more vectors are zero (e.g., signal being obstructed by obstacles). The information can indicate that one or more elements in a vector of the one or more vectors are zero. Alternatively, or in addition, the information indicates which element of a vector of the one or more vectors are non-zero.

In some embodiments, each vector of the one or more vectors is represented based on a dot product of a first vector and a second vector. The first vector comprises non-zero elements only, and the second vector comprises elements that are 0 or 1. In some embodiments, each vector of the one or more vectors comprises multiple sub-vectors, and the information indicates that one or more of the multiple sub-vectors include zero elements. In some embodiments, the information comprises an index of a zero sub-vector in the multiple sub-vectors, where all elements in the zero sub-vector are zeros. In some embodiments, the information comprises an index of a zero sub-vector for each of the one or more vectors respectively.

In some embodiments, the one or more vectors are organized into L sets of vectors, and for each of the L sets, the information comprises: an index of a zero sub-vector in the multiple sub-vectors, or indication information for indicating that one or more of the multiple sub-vectors include zero elements, where all elements of the zero sub-vector being zero, and wherein L is equal to 1 or larger than 1. In some embodiments, the L sets of vectors corresponds to R columns of the precoding matrix. In some embodiments, each of the R columns corresponding to one or two of the L sets of vectors, where L equals to R or 2×R.

In some embodiments, each vector of the one or more vectors comprises multiple sub-vectors and the information indicates a first coefficient of one of the multiple sub-vectors of a vector of the one or more vectors. In some embodiments, for each of the one or more vectors, the information includes a parameter shared by the multiple sub-vectors. In some embodiments, the parameter includes at least one of: (1) a second coefficient shared by the multiple sub vectors, or (2) an index of each vector among multiple predefined vectors.

In some embodiments, the one or more vectors correspond to R columns of the precoding matrix. In some embodiments, a column of the precoding matrix is based on a weighted sum of a set of vectors corresponding to the column, where the set of vector includes partial or all of the one or more vectors. In some embodiments, one or two of the one or more vectors corresponds to one of R columns of the precoding matrix. In some embodiments, the information indicates a respective first coefficient for each of the multiple sub-vectors of a vector.

In some embodiments, in response to a first sub-vector comprising zero elements, elements in a second sub-vector that is adjacent to the first sub-vector are determined to be zero. In some embodiments, a first half of the multiple sub-vectors (e.g., sub-vectors with indices being even numbers) corresponds to antenna ports in a first direction and a second half of the multiple sub-vectors (e.g., sub-vectors with indices being odd numbers) corresponds to antenna ports in a second direction. In response to a first sub-vector in the first half comprising zero elements, elements of a second sub-vector in the second half are determined to be zero, where the second sub-vector is associated with the first sub-vector.

In some embodiments, each of the one or more vectors comprises a same number of elements. In some embodiments, a vector of the one or more vectors includes at least one non-zero element. In some embodiments, each column of the precoding matrix and each of the one or more vectors have a same number of elements. In some embodiments, a number of elements in a column of the precoding matrix is twice the number of elements in each of the one or more vectors.

In some embodiments, the one or more vectors form a first group of vectors. The structure of the precoding matrix is further based on one or more additional vectors that form a second group of vectors. The information indicates that selected elements in a vector of the additional vectors are zero. In some embodiments, the first group of vectors corresponds to a first dimension of antenna ports of the reference signal and the second group of vectors corresponds to a second dimension of antenna ports of the reference signal. In some embodiments, the precoding matrix is based on a Kronecker product of a vector from the first group of vectors and a vector from the second group of vectors. In some embodiments, the one or more additional vectors share characteristics of the one or more vectors in the first group of vectors.

In some embodiments, each element of a vector of the one or more vectors is respectively associated with one or more antenna ports of the reference signal. In some embodiments, the information comprises one or more indices of one or more selected reference signal resources for each layer or each group of layers respectively. In some embodiments, a element of a vector for a layer or a group of layers is equal to a sum or half a sum of antenna ports of the one or more selected reference signal resources. In some embodiments, different columns of the precoding matrix for different layers include different numbers of elements. In some embodiments, a vector of the one or more vectors comprises multiple first sub-vectors, each sub-vector of the multiple first sub-vectors corresponding to one of the one or more selected reference signal resources. In some embodiments, the information indicates, for each layer or layer groups, a set of second sub-vectors corresponds to respective one of the multiple first sub vectors. The number of elements of a first sub vector equals to the number of elements of a second sub vector from the respective set of the second sub-vectors corresponding to the first sub vector. In some embodiments, a first sub vector is a weighted sum of the set of second sub vectors.

Details regarding the structure of the vector(s), the sub-vector(s), the precoding matrix, and the indication of the zero/non-zero elements of the precoding matrix are further discussed in the embodiments below.

### Embodiment 1

This embodiment is related to the precoding matrix design and precoding matrix reporting for a linear array of antenna elements or a uniform planar array. In this embodiment, a receiving device (e.g., a UE device) receives a reference signal from a transmitting device (e.g., a base station, or another UE device) using one or more antenna ports of the reference signal. The UE then determines a precoding matrix based on the reference signal. The precoding matrix is to indicate feedback information for antenna ports of the reference signals. The structure or the format of the precoding matrix is based on one or more vectors. The one or more vectors can be considered as spatial domain vectors in which each element of the one or more vectors correspond to parts of the antenna array. When the reference signal is invisible to the receiving device (e.g., being blocked by a scatterer), some elements in the vector are equal to zero.

In some embodiments, the structure or the format of the precoding matrix is based on a first type of vector (e.g., a vector of the one or more vectors) which includes N elements. The N elements can be organized as M groups of elements. For example, the N elements are grouped into M groups. The UE determines which group of the M groups of elements is a zero sub-vector with all elements being 0, indicating the presence of obstacles and/or scatterers. For example, X of the M groups of the first type vector have elements that are all equal to 0, where X is an integer equal to 0 or greater than 0. The remaining M-X groups of elements of first type of vector are non-zero values. Each of the M groups corresponds to a sub-vector.

In some implementation, the value of M is determined based on at least one of following: a signaling from the base station or another UE, and/or an indicator reported by the UE. In some implementations, the larger the value of N, the larger the value of M.

In some implementation, the M groups include the same number of elements in each group. In some implementation, the M groups includes different number of elements in different groups. How the N elements are organized into the M groups is determined based on at least: a signaling from the base station or another UE, an indicator reported by the UE, and/or a rule.

For example, N=16, M=4. That is, 16 elements in a vector are organized as 4 groups. For example, a vector with index s can be represented as

$${V}_{s} = [ \begin{matrix}0 \\ {W}_{1 , s} \\ 0 \\ {W}_{3 , s}\end{matrix} ] ,$$

where the X groups include the first and the third group. Alternatively, the vector with index s can be represented as

$${V}_{s} = [ \begin{matrix}0 \\ 0 \\ {W}_{2 , s} \\ {W}_{3 , s}\end{matrix} ] ,$$

wherein the X groups includes the first and the second group. W_{i,s} is a sub-vector

$${W}_{i , s} = [ \begin{matrix}{w}_{0 , i , s} \\ {w}_{1 , i , s} \\ ⋮ \\ {w}_{{N}_{i} , i , s}\end{matrix} ]$$

with index i among M sub-vectors of a vector with index s. Nᵢ is the number of elements of a group with index i among M groups.

In some embodiments, W_{i,s} is based on a product of (1) an index of an element among Nᵢ elements of the one group and (2) a parameter associated with the group that is applicable to all elements of the group. Each group of the M groups is respectively associated with one such parameter. For example, the element of W_{i,s} having an index n is based on one of the following:

$${w}_{n , i , s} = {a}_{i , s} exp ( j \frac{2 π ( {m}_{i , s} {O}_{i , s} + {q}_{i , s} )}{{N}_{i , s} {O}_{i , s}} n ) , {m}_{i , s} , n ∈ \{ 0 , 1 , … {N}_{i} - 1 \} , {q}_{i , s} ∈ \{ 0 , 1 , … O - 1 \} ; or \qquad Eq . ( 1 )$$

$${w}_{{n}_{1} * {N}_{1 , i} + {n}_{2} , i , s} = {a}_{i , s} exp ( j \frac{2 π ( {m}_{1 , i , s} {O}_{1 , i , s} + {q}_{1 , i , s} )}{{N}_{1 , i , s} {O}_{1 , i , s}} {n}_{1} + j \frac{2 π ( {m}_{2 , i , s} {O}_{2 , i , s} + {q}_{2 , i , s} )}{{N}_{2 , i , s} {O}_{2 , i , s}} {n}_{2} ) , {m}_{j , i , s} , {n}_{j} ∈ \{ 0 , 1 , … {N}_{j , i} - 1 \} , {q}_{j , i , s} ∈ \{ 0 , 1 , … {O}_{j} - 1 \} , j = 1 , 2. \qquad Eq . ( 2 )$$

The variable a_{i,s} is a coefficient. In some implementation, a_{i,s}=1. In some implementation, a_{i,s} is a coefficient reported by the UE. Eq. (2) is suitable for a uniform planar array (e.g., a planar array having two dimensions each of which has respective size).

In some embodiments, only one of the Nᵢ elements of the group is equal to 1, and other elements of the Nᵢ elements of the group are equal to 0. For example, the element with index n of W_{i,s} is based on:

$${W}_{i , s} = {a}_{i , s} {E}_{{n}_{i , s}} , {n}_{i , s} ∈ \{ 0 , 1 , … {N}_{i} - 1 \} \qquad Eq . ( 3 )$$

Here, Eₙ is a first type of vector with only one element having a value of 1; the remaining elements of Eₙ have a value of 0. The index of the only non-zero element among Nᵢ elements of the vector is n. For example,

$${W}_{2 , s} = {E}_{1} = [ \begin{matrix}0 \\ 1 \\ 0 \\ 0\end{matrix} ]$$

$${W}_{3 , s} = {E}_{2} = [ \begin{matrix}0 \\ 0 \\ 1 \\ 0\end{matrix} ]$$

In some embodiments, W_{i,s} is based on a product of (1) an index of an element among N elements of the first type of vector and (2) a parameter associated with the first type of vector that is applicable to all of the N elements. For example, the element with index n of W_{i,s} is based on:

$${w}_{n , i , s} = {a}_{i , s} exp ( j \frac{2 π ( {m}_{s} {O}_{s} + {q}_{s} )}{{N}_{s} {O}_{s}} n + B * {n}^{2} ) , {m}_{s} , n ∈ \{ 0 , 1 , … N - 1 \} , {q}_{s} ∈ \{ 0 , 1 , … O - 1 \} ; or \qquad Eq . ( 4 )$$

$${w}_{{n}_{1} * {N}_{1 , i} + {n}_{2} , i , s} = {a}_{i , s} exp ( j 2 π ( \frac{( {m}_{1 , s} {O}_{1 , s} + {q}_{1 , s} )}{{N}_{1 , s} {O}_{1 , s}} {n}_{1} + {b}_{1} * {( {n}_{1} )}^{2} + \frac{( {m}_{2 , s} {O}_{2 , s} + {q}_{2 , s} )}{{N}_{2 , s} {O}_{2 , s}} {n}_{2} + {b}_{2} * {( {n}_{2} )}^{2} ) , \qquad Eq . ( 5 )$$

$${m}_{j , s} , {n}_{j} ∈ \{ 0 , 1 , … {N}_{j} - 1 \} , {q}_{j , s} ∈ \{ 0 , 1 , … {O}_{j} - 1 \} , j = 1 , 2 , {V}_{s} = {a}_{s} {E}_{{n}_{s}} , {n}_{s} ∈ \{ 0 , 1 , … N - 1 \} , 0 \leq b < 1 , 0 \leq {b}_{j} < 1 , j = 1 , 2.$$

Eq. (5) is suitable for a uniform planar array (e.g., a planar array having two dimensions each of which has respective size). In some implementations, the number of elements in each of the M groups are same (e.g., the subscript i of Nᵢ in the equations above can be ignored). In another implementation, the number of elements in different groups can be different (e.g., the subscript i of Nᵢ in the equations above cannot be ignored).

In some implementations, the UE determines the indices of the X groups with all zero elements among the M groups. In some implementations, the UE reports the indices of the X groups to the base station. The base station and/or the UE determines the first type of vector based on the indices of the X groups having zero sub-vectors. Group with a sub vector 0 means that all elements of the group equal to 0.

For example, the UE determines the first and the second groups among the M=4 groups are zero sub-vectors. The first type of vector has following structure:

$${V}_{s} = [ \begin{matrix}0 \\ 0 \\ {W}_{2 , s} \\ {W}_{3 , s}\end{matrix} ]$$

As another example, the UE determines the first and the fourth groups among the M groups are zero sub-vectors. The first type of vector has following structure:

$${V}_{s} = [ \begin{matrix}0 \\ {W}_{1 , s} \\ {W}_{2 , s} \\ 0\end{matrix} ]$$

In some implementation, the UE determines the first type of vector based on a dot product of two vectors each of which includes N elements. The two vectors include a first vector having non-zero elements (each element of the N elements of the vector is not 0) and a second vector having elements that are 0 or 1 (e.g., X groups of the second vector are zero sub-vectors and the remaining M-X sub vectors are non-zero sub-vectors with all elements being is 1). For example, the first type of vector has following structure:

$${V}_{s} = [ \begin{matrix}{W}_{0 , s} \\ {W}_{1 , s} \\ {W}_{2 , s} \\ {W}_{3 , s}\end{matrix} ] \cdot [ \begin{matrix}0 \\ 0 \\ 1 \\ 1\end{matrix} ] = [ \begin{matrix}0 \\ 0 \\ {W}_{2 , s} \\ {W}_{3 , s}\end{matrix} ]$$

Here, Vₛ is the first type of vector. [W_{0,s} W_{1,s} W_{2,s} W_{3,s}]^{T} and [0 0 1 1]^{T} are the two vectors used to represent the first type of vector.

In some implementations, a spatial domain vector can be considered as the first type of vector. The two vectors are intermediate vectors that are used to represent the first type vector and can be referred to as intermediate spatial domain vectors.

In some implementation, the precoding matrix is based on S first type of vectors, where S is equal to 1 or greater than 1. Each of the S first type of vectors includes same number of elements, such as N elements. If S is larger than 1, the UE determines the index of groups having zero elements (zero sub-vectors) for each of the S vectors respectively. For example, the index of a group with zero elements for a first vector is 0 and the first vector has an index 0 of the S first type of vectors. The first vector can be represented as:

$${V}_{0} = [ \begin{matrix}0 \\ {W}_{1 , 0} \\ {W}_{2 , 0} \\ {W}_{3 , 0}\end{matrix} ] .$$

When the indices of groups with zero elements for a second vector are {2,3} and the second vector has an index of 1 of the S first type of vectors, the second vector can be represented as:

$${V}_{1} = [ \begin{matrix}{W}_{0 , 1} \\ {W}_{1 , 1} \\ 0 \\ 0\end{matrix} ] .$$

The W_{i,s}, i∈{0, 1, . . . M−1} for different first type of vectors can be different. In some implementation, for each vector s∈{0, 1, . . . S−1}, there is no relationship between the sub-vector(s) of the vectors that are non-zero sub-vector(s) W_{i,s}, i=0, 1 . . . M−1. Each of the non-zero sub-vector for a vector is determined by a respective parameter.

In some implementations, for each vector s∈{0, 1, . . . . S−1}, there is a relationship between the non-zero sub vector(s) of the vectors. For example, the non-zero sub-vector(s) for multiple vectors can be determined by a shared or a common parameter. As another example, the non-zero sub-vector(s) for multiple vectors can be determined by a first shared parameter and subsequently by respective parameters.

In some implementations, the precoding matrix is based on S first type of vectors that are divided to L sets. The UE determines and reports the index of groups with zero values (e.g., zero sub-vectors) for each of the L sets respectively. The indices of groups with zero elements for the first type of vectors in one of the L sets of first type of vectors can be the same. For example, if L=2, the L sets include the first set of first type of vectors {V₀,V₃} and the second set of first type of vectors {V₁,V₂,V₄}. For the first set of first type of vectors, the UE determines that the index of a group with zero elements is 0. {V₀,V₃} have the following structure:

$${V}_{0} = [ \begin{matrix}0 \\ {W}_{1 , 0} \\ {W}_{2 , 0} \\ {W}_{3 , 0}\end{matrix} ] and {V}_{3} = [ \begin{matrix}0 \\ {W}_{1 , 3} \\ {W}_{2 , 3} \\ {W}_{3 , 3}\end{matrix} ] .$$

The UE determines the indices of groups with zero elements are 2 and 3 for the second set of first type of vectors. The {V₁,V₂,V₄} has following structures:

$${V}_{1} = [ \begin{matrix}{W}_{0 , 1} \\ {W}_{1 , 1} \\ 0 \\ 0\end{matrix} ] , {V}_{2} = [ \begin{matrix}{W}_{0 , 2} \\ {W}_{1 , 2} \\ 0 \\ 0\end{matrix} ] , {V}_{4} = [ \begin{matrix}{W}_{0 , 4} \\ {W}_{1 , 4} \\ 0 \\ 0\end{matrix} ] .$$

In some implementation, each of the L sets corresponds to a same parameter. For example, each set corresponds to one layer. Different layers correspond to different sets of the L sets.

In some embodiments, the UE determines which group of M groups has zero elements (a zero sub-vector) for each of the S first type of vectors. In some embodiments, the UE determines and reports a coefficient for each sub-vector of a vector of the S first type of vectors. The coefficient can include amplitude information only. Alternatively, or in addition, the coefficient includes amplitude information and phase information. For example, one first type of vector with index s can have the structure represented as:

$${V}_{s} = [ \begin{matrix}{a}_{0 , s} {W}_{0 , s} \\ {a}_{1 , s} {W}_{1 , s} \\ {a}_{2 , s} {W}_{2 , s} \\ {a}_{3 , s} {W}_{3 , s}\end{matrix} ] \qquad Eq . ( 6 )$$

where a_{i,s}, i=0, 1, . . . , M−1, s=0, 1, . . . , S−1 represents the coefficient (e.g., the first coefficient) of the sub vector with index i for the first type of vector with index s. The W_{i,s} can be determined using the examples discussed above.

In some embodiments, the M sub vectors share a same parameter that is used to determine the M sub-vectors. For example, the UE reports a parameter for a vector Vₛ. The parameter can be an index of Vₛ among multiple predefined vectors. For example, the parameter includes at least one of mₛ, qₛ, b, m_{1,s}, q_{1,s}, b₁, m_{2,s}, q_{2,s}, or b₂. In some implementation, α_{i,s} represents amplitude information and 0≤α_{i,s}≤1. In some embodiments, α_{i,s} represents amplitude information and phase information, and 0≤|α_{i,s}|≤1. If the precoding matrix is based on a weighted sum of multiple first type of vectors, the parameter also includes a second coefficient corresponding to the Vₛ and shared by the M sub vector, such as the second coefficient β as shown in following description.

In some embodiments, the precoding matrix includes R columns, where R is an integer equal to or greater than 1. In some embodiments, the transmission is determined with R layers and each of the column corresponds to one of R layers.

In some embodiments, S equals to R or 2×R. Each of S first type of vectors corresponds to one of the R layers. Different layers correspond to a vector having a different index among the S first type of vectors. Each layer corresponds to one or two first type of vectors of the S first type of vectors. For example, the column with an index l among the R columns can have one of the following structures:

$${P}_{l} = {V}_{s} , l ∈ \{ 0 , 1 , … R - 1 \}$$

$${P}_{l} = [ \begin{matrix}{β}_{l , 1} {V}_{s} \\ {β}_{l , 2} {V}_{s}\end{matrix} ] , l ∈ \{ 0 , 1 , … R - 1 \}$$

$${P}_{l} = [ \begin{matrix}{β}_{l , 1} {V}_{s , 1} \\ {β}_{l , 2} {V}_{s , 2}\end{matrix} ] , l ∈ \{ 0 , 1 , … R - 1 \}$$

Among the three structures above, the last two structures can be more suitable for two polarization directions and the first structure can be suitable more suitable for one or two polarization directions. Each layer corresponds to two first type of vectors of the S first type of vectors in the last two structures. Both V_{s,1} and V_{s,2} are vectors of the first type. They can be determined based on example ways described above. The UE determines and reports the indices of groups with zero elements (sub-vectors) for the V_{s,1} and V_{s,2} respectively. β_{l,i}, i=1, 2 is a coefficient (e.g., the second coefficient). In some implementation, at least one of β_{l,1} or β_{l,2} is equal to 1. If the first type of vector is determined by Eq. (6), the UE reports a first coefficient α_{i,s} for each of the M sub-vectors of the S first type of vectors and one or two second coefficients β_{l,1} and β_{l,2} for each of the S first type of vectors.

In some embodiments, the precoding matrix is based on R sets of first type of vectors. The S first type of vector includes all first type vectors across the R sets of first type of vectors. Each of the R columns corresponds to one set of the first type of vectors respectively. The R columns corresponds to R sets of the first type of vectors. One column of the precoding matrix is based on a weighted sum of vectors in one set of the first type of vectors corresponding to the one column. For example, the column with an index l among the R columns can have one of the following structures:

$${P}_{l} = {\sum }_{s = 0}^{{S}_{l} - 1} {β}_{l , s} {V}_{l , s} , l ∈ \{ 0 , 1 , … R - 1 \} \\ {P}_{l , t} = {\sum }_{s = 0}^{{S}_{l} - 1} {V}_{l , s} {\sum }_{d = 0}^{{D}_{l} - 1} {β}_{l , s , d} {g}_{l , t}^{d} , t ∈ \{ 0 , 1 , … , T - 1 \} \\ {P}_{l} = {\sum }_{s = 0}^{{S}_{l} - 1} {V}_{l , s} {\sum }_{d = 0}^{{D}_{l} - 1} {β}_{l , s , d} {g}_{t}^{d} , t ∈ \{ 0 , 1 , … , T - 1 \} \\ {P}_{l} = [ \begin{matrix}{\sum }_{s = 0}^{{S}_{l} - 1} {β}_{l , s , 1} {V}_{l , s} \\ {\sum }_{s = 0}^{{S}_{l} - 1} {β}_{l , s , 2} {V}_{l , s}\end{matrix} ] , l ∈ \{ 0 , 1 , … R - 1 \} \\ {P}_{l , t} = [ \begin{matrix}{\sum }_{s = 0}^{{S}_{l} - 1} {V}_{l , s} {\sum }_{d = 0}^{{D}_{l} - 1} {β}_{l , s , d , 1} {g}_{l , t}^{d} \\ {\sum }_{s = 0}^{{S}_{l} - 1} {V}_{l , s} {\sum }_{d = 0}^{{D}_{l} - 1} {β}_{l , s , d , 2} {g}_{l , t}^{d}\end{matrix} ] , t ∈ \{ 0 , 1 , … , T - 1 \} \\ {P}_{l , t} = [ \begin{matrix}{\sum }_{s = 0}^{{S}_{l} - 1} {V}_{l , s} {\sum }_{d = 0}^{{D}_{l} - 1} {β}_{l , s , d , 1} {g}_{t}^{d} \\ {\sum }_{s = 0}^{{S}_{l} - 1} {V}_{l , s} {\sum }_{d = 0}^{{D}_{l} - 1} {β}_{l , s , d , 2} {g}_{t}^{d}\end{matrix} ] , t ∈ \{ 0 , 1 , … , T - 1 \}$$

In some embodiments, the precoding matrix is based on 2×R sets of first type of vectors. The S first type of vector includes all first type vectors across the 2×R sets of first type of vectors. Each of the R columns corresponds to two sets of the first type of vectors respectively. The R columns corresponds to 2×R sets of the first type of vectors. Each half of one column of the precoding matrix is based on a weighted sum of vectors in one set of the first type of vectors corresponding to the one column. For example, the column with an index l among the R columns can have one of the following structures:

$${P}_{l} = [ \begin{matrix}{\sum }_{s = 0}^{{S}_{l} - 1} {β}_{l , s , 1} {V}_{l , s , 1} \\ {\sum }_{s = 0}^{{S}_{l} - 1} {β}_{l , s , 2} {V}_{l , s , 2}\end{matrix} ] , l ∈ \{ 0 , 1 , … R - 1 \} \\ {P}_{l , t} = [ \begin{matrix}{\sum }_{s = 0}^{{S}_{l} - 1} {V}_{l , s , 1} {\sum }_{d = 0}^{{D}_{l} - 1} {β}_{l , s , d , 1} {g}_{l , t}^{d} \\ {\sum }_{s = 0}^{{S}_{l} - 1} {V}_{l , s , 2} {\sum }_{d = 0}^{{D}_{l} - 1} {β}_{l , s , d , 2} {g}_{l , t}^{d}\end{matrix} ] , t ∈ \{ 0 , 1 , … , T - 1 \} \\ {P}_{l , t} = [ \begin{matrix}{\sum }_{s = 0}^{{S}_{l} - 1} {V}_{l , s , 1} {\sum }_{d = 0}^{{D}_{l} - 1} {β}_{l , s , d , 1} {g}_{t}^{d} \\ {\sum }_{s = 0}^{{S}_{l} - 1} {V}_{l , s , 2} {\sum }_{d = 0}^{{D}_{l} - 1} {β}_{l , s , d , 2} {g}_{t}^{d}\end{matrix} ] , t ∈ \{ 0 , 1 , … , T - 1 \}$$

Among the nine structures above, the last sixth structures are more suitable for two polarization directions. The first three structures can be suitable for one or two polarization directions. Both V_{l,s,1} and V_{l,s,2} are vectors of the first type. They can be determined by the similar way to determine Vₛ as described above. The UE determines and reports the indices of groups with zero elements (sub-vectors) for the V_{l,s,1} and V_{l,s,2} respectively. β_{l,s} is a coefficient and V_{l,s} is determined by same way of determining above. V_{l,s} is determined by same way of determining above Vₛ except for the subscript s is replaced with l,s for Vₛ and W_{i,s}. The last sixth structures use the same frequency domain vectors for the two half elements of one column of the precoding matrix. Alternative, or in addition, for the last sixth structures, the two half elements correspond to different frequency domain vectors. That is,

$${g}_{t}^{d} or {g}_{l , t}^{d}$$

can be replaced with

$${g}_{t , 1}^{d} or {g}_{l , t , 1}^{d}$$

respectively for the first half elements, and

$${g}_{t}^{d} or {g}_{l , t}^{d}$$

can be replaced with

$${g}_{t , 2}^{d} or {g}_{l , t 21}^{d}$$

respectively for the second half elements. For example, the last structure of the precoding matrix can have the following format:

$${P}_{l , t} = [ \begin{matrix}{\sum }_{s = 0}^{{S}_{l} - 1} {V}_{s , 1} {\sum }_{d = 0}^{{D}_{l} - 1} {β}_{l , s , d , 1} {g}_{t , 1}^{d} \\ {\sum }_{s = 0}^{{S}_{l} - 1} {V}_{s , 2} {\sum }_{d = 0}^{{D}_{l} - 1} {β}_{l , s , d , 2} {g}_{t , 2}^{d}\end{matrix} ] , t ∈ \{ 0 , 1 , … , T - 1 \}$$

When Sₗ=1, the column is based on only one first type of vector. For example, the weighted vector can be one first type vector that is used to determine the column. In some implementations, if Sₗ=1 and β_{l,s}=1, the one set of the first type of vectors of column l includes Sₗ of V_{l,s}. In some implementations, different sets of the first type of vectors for different columns include different number of first type of vectors. In some implementations, the R sets or 2×R sets of the first type of vectors for R columns include the same number of first type of vectors (e.g., the subscript l of Sₗ can be ignored).

In some embodiments, the variable β_{l,s,d} a weighted coefficient of the s^{th} first type of vector and d^{th} second type of vectors for layer l. The second type of vectors can be considered as frequency domain vectors used for determining the precoding matrix. The variable

$${g}_{t}^{d}$$

is the t^{th} element or one second type vector that includes T elements, and

$${g}_{t}^{d} = exp ( j 2 π \frac{t * {k}^{d}}{T} ) , {k}^{d} ∈ \{ 0 , 1 , … , T - 1 \} .$$

In some implementations, the variable

$${g}_{l , t}^{d}$$

is the t^{th} element of one second type of vector that includes T elements and corresponds to layer l, and

$${g}_{l , t}^{d} = exp ( j 2 π \frac{t * {k}_{l}^{d}}{T} ) , {k}_{l}^{d} ∈ \{ 0 , 1 , … , T - 1 \} .$$

### Variables

$${g}_{t , 1}^{d} , {g}_{t , 2}^{d} , {g}_{l , t , 1}^{d} , {g}_{l , t , 2}^{d}$$

are the second type of vectors and can be determined using the similar method for determining

$${g}_{l , t}^{d} or {g}_{t}^{d} .$$

For example,

$${g}_{t , j}^{d} = exp ( j 2 π \frac{t * {k}_{j}^{d}}{T} ) , {k}_{j}^{d} ∈ \{ 0 , 1 , … , T - 1 \} , j = 1 , 2 \\ {g}_{l , t , j}^{d} = exp ( j 2 π \frac{t * {k}_{l , j}^{d}}{T} ) , {k}_{l , j}^{d} ∈ \{ 0 , 1 , … , T - 1 \} , j = 1 , 2 .$$

In some embodiments, there are T frequency domain units. The number Dₗ of second type of vectors (e.g., frequency domain vectors) for different layers can be different. In some implementations, the number of the second type vectors for at least two layers are same (e.g., Dₗ₁=Dₗ₂). In some implementations, the number of frequency domain vectors for all layers remains the same (e.g., the subscript l can be ignored).

In some embodiments, the variable P_{l,t} is the column with an index l among the R columns of a precoding matrix on a frequency domain unit with index t, t∈{0, 1, . . . T−1}. The variable β_{l,s,d,j} is a weighted coefficient of the s^{th} first type of vector and d^{th} second type of vector for layer l for the j^{th} half reference signal antenna ports. β_{l,s,d,j} is also a second coefficient. In some implementations, the UE reports

$${k}^{d} , {k}_{l}^{d} {k}_{j}^{d} , or {k}_{l , j}^{d} .$$

The information of the precoding matrix includes at least one of

$${k}^{d} , {k}_{l}^{d} {k}_{j}^{d} , or {k}_{l , j}^{d} .$$

If the first type of vector is determined by Eq. (6), the UE reports a first coefficient α_{i,s} for each of the M sub-vectors of each of the S first type of vectors and one or more second coefficients such as β_{l,s,j}, β_{l,s,d,j}, j=1, 2 for each of the S first type of vector. For each of the first type of vectors, the number of the first coefficient α_{i,s} associated with a sub vector of the first type of vector can be more than 1, but the number of the second coefficient β_{l,s,j}, β_{l,s,d,j} associated with the first type of vector is one. In some implementations, the UE reports a first coefficient α_{i,s} for one or more of the M sub-vectors of each of the S first type of vectors.

In some embodiments, the R columns share the same set of first type of vectors. Each column is a respective weighted vector of the same set of first type of vectors. For example, the column with an index l among the R columns can have one of following structures:

$${P}_{l} = {\sum }_{s = 0}^{S - 1} {β}_{l , s} {V}_{s} , l ∈ \{ 0 , 1 , … R - 1 \}$$

$${P}_{l , t} = {\sum }_{s = 0}^{{S}_{l} - 1} {V}_{s} {\sum }_{d = 0}^{{D}_{l} - 1} {β}_{l , s , d} {g}_{l , t}^{d} , t ∈ \{ 0 , 1 , … , T - 1 \}$$

$${P}_{l , t} = {\sum }_{s = 0}^{{S}_{l} - 1} {V}_{s} {\sum }_{d = 0}^{{D}_{l} - 1} {β}_{l , s , d} {g}_{t}^{d} , t ∈ \{ 0 , 1 , … , T - 1 \}$$

$${P}_{l} = [ \begin{matrix}{\sum }_{s = 0}^{S - 1} {β}_{l , s , 1} {V}_{s} \\ {\sum }_{s = 0}^{S - 1} {β}_{l , s , 2} {V}_{s}\end{matrix} ] , l ∈ \{ 0 , 1 , … R - 1 \}$$

$${P}_{l , t} = [ \begin{matrix}{\sum }_{s = 0}^{{S}_{l} - 1} {V}_{s} {\sum }_{d = 0}^{{D}_{l} - 1} {β}_{l , s , d , 1} {g}_{l , t}^{d} \\ {\sum }_{s = 0}^{{S}_{l} - 1} {V}_{s} {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{s} {\sum }_{d = 0}^{{D}_{l} - 1} {β}_{l , s , d , 1} {g}_{t}^{d} \\ {\sum }_{s = 0}^{{S}_{l} - 1} {V}_{s} {\sum }_{d = 0}^{{D}_{l} - 1} {β}_{l , s , d , 2} {g}_{t}^{d}\end{matrix} ] , t ∈ \{ 0 , 1 , … , T - 1 \}$$

$${P}_{l} = [ \begin{matrix}{\sum }_{s = 0}^{S - 1} {β}_{l , s , 1} {V}_{s , 1} \\ {\sum }_{s = 0}^{S - 1} {β}_{l , s , 2} {V}_{s , 2}\end{matrix} ] , l ∈ \{ 0 , 1 , … R - 1 \}$$

$${P}_{l , t} = [ \begin{matrix}{\sum }_{s = 0}^{{S}_{l} - 1} {V}_{s , 1} {\sum }_{d = 0}^{{D}_{l} - 1} {β}_{l , s , d , 1} {g}_{l , t}^{d} \\ {\sum }_{s = 0}^{{S}_{l} - 1} {V}_{s , 2} {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{s , 1} {\sum }_{d = 0}^{{D}_{l} - 1} {β}_{l , s , d , 1} {g}_{t}^{d} \\ {\sum }_{s = 0}^{{S}_{l} - 1} {V}_{s , 2} {\sum }_{d = 0}^{{D}_{l} - 1} {β}_{l , s , d , 2} {g}_{t}^{d}\end{matrix} ] , t ∈ \{ 0 , 1 , … , T - 1 \}$$

Among the nine structures above, the last sixth structures are more suitable for two polarization directions and the first three structures are suitable for one or two polarization directions. In some embodiments, both V_{s,1} and V_{s,2} represent a first type of vector. They can be determined based on the similar method(s) to determine Vₛ. The UE determines and reports the indices of groups with zero elements (e.g., zero sub-vector) for V_{s,1} and V_{s,2} respectively. The indices of zero sub-vectors of each of the S first type of vectors Vₛ is determined by the UE respectively. The UE reports the index of zero sub-vector for each of the S first type of vectors Vₛ. If the first type of vector is determined Eq. (6), the UE reports a coefficient α_{i,s} for each of the M sub vectors of each of the S first type of vectors and one or more coefficients such as β_{l,s,j}, β_{l,s,d,j}, j=1, 2 for each of the S first type of vectors.

For each of the first type of vectors, the number of coefficients α_{i,s} associated with a sub-vector of M sub-vectors for one of the first type of vector can be more than 1, but the number of coefficients β_{l,s,j}, β_{l,s,d,j} associated with the one first type of vectors is 1. The S first type of vectors are shared by different layers or different half reference antenna ports. For different layers or different half reference antenna ports, the coefficient of the first type of vector can be different and reported respectively. The coefficients of sub vector remain unchanged and reported once for each sub vector of each first type of vectors. For example, the subscript of α_{i,s} only includes the index i of sub vector and an index of the first type of vector, and does not include the layer index or frequency domain vector index.

In some embodiments, the first type of vector is based on a dot product of two vectors each of which includes N elements. The two vectors include a first vector having non-zero elements and a second vector having elements that are 0 or 1. R sets of first type of vectors are based on the same set of non-zero vectors. For example, the column with an index l among the R columns can have one of the following structures:

$${P}_{l} = {\sum }_{s = 0}^{S - 1} {β}_{l , s} ( {V}_{s}^{1} {V}_{l , s}^{2} ) , l ∈ \{ 0 , 1 , … R - 1 \}$$

$${P}_{l , t} = {\sum }_{s = 0}^{{S}_{l} - 1} ( {V}_{s}^{1} {V}_{l , s}^{2} ) {\sum }_{d = 0}^{{D}_{l} - 1} {β}_{l , s , d} {g}_{l , t}^{d} , t ∈ \{ 0 , 1 , … , T - 1 \}$$

$${P}_{l , t} = {\sum }_{s = 0}^{{S}_{l} - 1} ( {V}_{s}^{1} {V}_{l , s}^{2} ) {\sum }_{d = 0}^{{D}_{l} - 1} {β}_{l , s , d} {g}_{t}^{d} , t ∈ \{ 0 , 1 , … , T - 1 \}$$

$${P}_{l} = [ \begin{matrix}{\sum }_{s = 0}^{S - 1} {β}_{l , s , 1} ( {V}_{s}^{1} {V}_{l , s}^{2} ) \\ {\sum }_{s = 0}^{S - 1} {β}_{l , s , 2} ( {V}_{s}^{1} {V}_{l , s}^{2} )\end{matrix} ] , l ∈ \{ 0 , 1 , … R - 1 \}$$

$${P}_{l , t} = [ \begin{matrix}{\sum }_{s = 0}^{{S}_{l} - 1} ( {V}_{s}^{1} {V}_{l , s}^{2} ) {\sum }_{d = 0}^{{D}_{l} - 1} {β}_{l , s , d , 1} {g}_{l , t}^{d} \\ {\sum }_{s = 0}^{{S}_{l} - 1} ( {V}_{s}^{1} {V}_{l , s}^{2} ) {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} ( {V}_{s}^{1} {V}_{l , s}^{2} ) {\sum }_{d = 0}^{{D}_{l} - 1} {β}_{l , s , d , 1} {g}_{l , t}^{d} \\ {\sum }_{s = 0}^{{S}_{l} - 1} ( {V}_{s}^{1} {V}_{l , s}^{2} ) {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l} = [ \begin{matrix}{\sum }_{s = 0}^{S - 1} {β}_{l , s , 1} ( {V}_{s , 1}^{1} {V}_{l , s , 1}^{2} ) \\ {\sum }_{s = 0}^{S - 1} {β}_{l , s , 2} ( {V}_{s , 2}^{1} {V}_{l , s , 2}^{2} )\end{matrix} ] , l ∈ \{ 0 , 1 , … R - 1 \}$$

$${P}_{l , t} = [ \begin{matrix}{\sum }_{s = 0}^{{S}_{l} - 1} ( {V}_{s , 1}^{1} {V}_{l , s , 1}^{2} ) {\sum }_{d = 0}^{{D}_{l} - 1} {β}_{l , s , d , 1} {g}_{l , t}^{d} \\ {\sum }_{s = 0}^{{S}_{l} - 1} ( {V}_{s , 2}^{1} {V}_{l , s , 2}^{2} ) {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} ( {V}_{s , 1}^{1} {V}_{l , s , 1}^{2} ) {\sum }_{d = 0}^{{D}_{l} - 1} {β}_{l , s , d , 1} {g}_{t}^{d} \\ {\sum }_{s = 0}^{{S}_{l} - 1} ( {V}_{s , 2}^{1} {V}_{l , s , 2}^{2} ) {\sum }_{d = 0}^{{D}_{l} - 1} {β}_{l , s , d , 2} {g}_{t}^{d}\end{matrix} ] , t ∈ \{ 0 , 1 , … , T - 1 \}$$

Among the nine example structures above, the last sixth structures are more suitable for two polarization directions and the first three structures can be suitable one or two polarization directions. Both

$${V}_{l , s , 1} = {V}_{s , 1}^{1} {V}_{l , s , 1}^{2} and {V}_{l , s , 2} = {V}_{s , 2}^{1} {V}_{l , s , 2}^{2}$$

represent first type of vectors The UE determines and reports the indices of groups zero elements (e.g., zero sub-vectors) for V_{l,s,1} and V_{l,s,2} respectively. The variable

$${V}_{s}^{1}$$

represents the non-zero element vector with index s among S vectors. Variable

$${V}_{l , s}^{2}$$

represents the vector Of 1 or 0 elements with index s among S vectors for column l. The variable

$${V}_{s , j}^{1} , j = 1 , 2$$

represents the non-zero element vector with index s among S vectors for the j^{th} half reference signal antenna ports. They are also for the j^{th} half elements of the column. The variable

$${V}_{l , s , j}^{2} , j = 1 , 2$$

represents the vector of 1 or 0 elements with index s among S vectors for column l for the j^{th} half reference signal antenna ports. In some implementations, the first half elements of the column and the second half elements of the column correspond to antenna ports in horizontal and vertical respectively.

In some implementations, adjacent groups of the M groups are correlated (e.g., representing antennas that are geospatially close to each other). If a group with index n among M groups is determined be a zero sub-vector, then an adjacent group with index n+1 and/or n−1 is determined be a zero sub-vector as well. In some implementations, groups of M groups with indices being odd or even numbers are correlated (e.g., representing antennas configured with similar beams). If a group with index n among M groups is determined be a zero sub-vector, then the group with index n+M/2 and/or n−M/2 is determined be a zero sub-vector as well.

In some implementation, the UE determines which group of the first type of vector is a zero sub-vector. The UE determines one or more reference signal antenna groups from M reference signal antenna groups. The first type of vector is based on the selected one or more reference signal antenna groups. Each group of the first type of vector corresponds to one antenna port group of references signal. The N elements of the first type of vector corresponds to N antenna ports of reference signal(s), such as measurement reference signal(s). The measurement antenna ports corresponding to the remaining M-X groups of elements of the first type of vector are the measurement antenna ports selected by the UE for the first type of vector. For example, the UE reports the index of zero sub-vector among M sub vectors for each of S first type vectors respectively. Alternatively, or in addition, the UE reports the index of the zero sub-vector for each of the L sets of first type of vectors respectively. As another example, the UE reports the index of sub vector with non-zero elements (e.g., no element is 0) among M sub vectors for each of S first type vectors. Alternatively, or in addition, the UE reports the index of non-zero sub-vector (no element in the sub-vector is zero) for each of the L sets of first type of vectors. The remaining sub-vector(s) are considered as zero sub-vectors.

In some implementations, the first type of vector can be considered as one of a spatial domain vector, a spatial domain vector in horizontal direction, or a spatial domain vector in vertical direction. Each element of the first type of vector corresponds to one or more antenna ports of reference signal. For example, if the elements of the first type of vector is determined by Eq. (2) or Eq. (5), then the first type of vector can be considered as a spatial domain vector. The spatial domain vector is two-dimensional including a horizontal direction and a vertical direction. Each element of the spatial domain vector corresponds to one or two reference signal antenna ports. The two reference signal antenna ports correspond to two polarization antenna ports. If the elements of the first type of vector is determined by Eq. (1) or Eq. (4), then the first type of vector can be considered as a horizontal spatial domain vector or a vertical spatial domain vector. Each element of the spatial domain vector corresponds to one or more reference signal antenna ports. The reference signal antenna ports correspond to one horizontal direction antenna port and one vertical direction antenna port group for each polarization direction. Alternatively, the reference signal antenna ports correspond to one vertical direction antenna port and one horizontal direction antenna port group for each polarization direction.

### Embodiment 2

This embodiment is related to the precoding matrix design and precoding matrix reporting for a two-dimensional array of antenna elements. Here, the first type of vectors corresponds to a first dimension of the antenna array and a third type of vectors (e.g., the additional vectors) is defined to correspond to a second dimension of the antenna array. The third type of vectors have similar characteristics as the first type of vectors described in Embodiment 1.

The precoding matrix is based on a fifth type of vector, and the fifth type of vector is obtained based on the first type of vectors and the third type of vectors. The third type of vector includes N₁ elements which are divided to M₁ groups. The first type of vector includes N₂ elements which are divided to M₂ groups. The fifth type of vector include N₁*N₂ elements. For example, the fifth type of vector has following structure:

$${V}_{s}^{5} = {V}_{{s}_{1}}^{3} ⊗ {V}_{{s}_{2}}^{1} = [ \begin{matrix}{v}_{0 , {s}_{1}}^{3} {V}_{{s}_{2}}^{1} \\ {v}_{1 , {s}_{1}}^{3} {V}_{{s}_{2}}^{1} \\ ⋮ \\ {v}_{{N}_{1} , {s}_{1}}^{3} {V}_{{s}_{2}}^{1}\end{matrix} ]$$

For example, each of the first type of vector is a spatial domain vector in horizontal direction. Each of the third type of vector is a spatial domain vector in vertical direction. The UE determines zero sub-vectors of the third type vector and zero sub-vectors of the first type of vector using example methods described in Embodiment 1 above.

In some implementation, the precoding matrix is based on S fifth type of vectors which is based on S₁ third type of vectors and S₂ first type of vectors. S is smaller than or equals to S₁*S₂. The UE determines zero sub-vectors for each of the S₁ third type of vectors and for each of the S₂ first type of vectors respectively. Each of the S fifth type of vectors is a Kronecker product of one of the S₁ third type of vectors and one of the S₂ first type of vectors.

In some implementation, the precoding matrix includes R columns, where R is an integer equal to or greater than 1. R columns of the precoding matrix correspond to the R transmissions layers.

In some embodiments, S is equal to R. Each of S fifth type of vectors corresponds to one of the R layers. Different layers correspond to a fifth type of vector with different index among the S fifth type of vectors. For example, the column with an index l among the R columns has one of following structures, where s=l:

$${P}_{l} = {V}_{s}^{5} , l ∈ \{ 0 , 1 , … R - 1 \}$$

In some embodiments, S is equal to 2×R. Two of S fifth type of vectors corresponds to one of the R layers. Different layers correspond to two fifth type of vectors with different index among the S fifth type of vectors. For example, the column with an index l among the R columns has one of following structures, where s=l:

$${P}_{l} = [ \begin{matrix}{β}_{l , 1} {V}_{s}^{5} \\ {β}_{l , 2} {V}_{s}^{5}\end{matrix} ] , l ∈ \{ 0 , 1 , … R - 1 \}$$

$${P}_{l} = [ \begin{matrix}{β}_{l , 1} {V}_{s , 1}^{5} \\ {β}_{l , 2} {V}_{s , 2}^{5}\end{matrix} ] , l ∈ \{ 0 , 1 , … R - 1 \}$$

Among the three structures above, the last two structures are more suitable for two polarization directions and the first structure can be suitable for one or two polarization directions. Both

$${V}_{s , 1}^{5} and {V}_{s , 2}^{5}$$

are fifth type of vectors. They can be determined based on a similar manner to determine

$${V}_{s}^{5} .$$

The UE determines and reports the indices of groups with zero elements (e.g., zero sub-vectors) for the

$${V}_{s , 1}^{5} and {V}_{s , 2}^{5}$$

respectively. The variable β_{l,i}, i=1, 2 is a coefficient. In some implementations, at least one of β_{l,1} and β_{l,2} is 1.

In some embodiments, each of the R columns corresponds to one set of the fifth type of vectors respectively. The R columns corresponds to R sets of the fifth type of vectors. Each column of the precoding matrix is based on a weighted sum of fifth type of vectors in one set of the fifth type of vectors corresponding to the one column. For example, the column with an index l among the R columns has one of following structures:

$${P}_{l} = {\sum }_{s = 0}^{{S}_{l} - 1} {β}_{l , s} {V}_{l , s}^{5} , l ∈ \{ 0 , 1 , … R - 1 \}$$

$${P}_{l , t} = {\sum }_{s = 0}^{{S}_{l} - 1} {V}_{l , s}^{5} {\sum }_{d = 0}^{{D}_{l} - 1} {β}_{l , s , d} {g}_{l , t}^{d} , t ∈ \{ 0 , 1 , … , T - 1 \}$$

$${P}_{l , t} = {\sum }_{s = 0}^{{S}_{l} - 1} {v}_{l , s}^{5} {\sum }_{d = 0}^{{D}_{l} - 1} {β}_{l , s , d} {g}_{t}^{d} , t ∈ \{ 0 , 1 , … , T - 1 \}$$

In some embodiments, each of the R columns corresponds to two sets of the fifth type of vectors respectively. The R columns corresponds to 2×R sets of the fifth type of vectors. Each half elements of each column of the precoding matrix are based on a weighted sum of fifth type of vectors in one set of the fifth type of vectors corresponding to the one column. For example, the column with an index l among the R columns has one of following structures:

$${P}_{l} = [ \begin{matrix}{\sum }_{s = 0}^{{S}_{l} - 1} {β}_{l , s , 1} {V}_{l , s}^{5} \\ {\sum }_{s = 0}^{{S}_{l} - 1} {β}_{l , s , 2} {V}_{l , s}^{5}\end{matrix} ] , l ∈ \{ 0 , 1 , … R - 1 \}$$

$${P}_{l , t} = [ \begin{matrix}{\sum }_{s = 0}^{{S}_{l} - 1} {V}_{l , s}^{5} {\sum }_{d = 0}^{{D}_{l} - 1} {β}_{l , s , d , 1} {g}_{l , t}^{d} \\ {\sum }_{s = 0}^{{S}_{l} - 1} {V}_{l , s}^{5} {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{l , s}^{5} {\sum }_{d = 0}^{{D}_{l} - 1} {β}_{l , s , d , 1} {g}_{t}^{d} \\ {\sum }_{s = 0}^{{S}_{l} - 1} {V}_{l , s}^{5} {\sum }_{d = 0}^{{D}_{l} - 1} {β}_{l , s , d , 2} {g}_{t}^{d}\end{matrix} ] , t ∈ \{ 0 , 1 , … , T - 1 \}$$

$${P}_{l} = [ \begin{matrix}{\sum }_{s = 0}^{{S}_{l} - 1} {β}_{l , s , 1} {V}_{l , s , 1}^{5} \\ {\sum }_{s = 0}^{{S}_{l} - 1} {β}_{l , s , 2} {V}_{l , s , 2}^{5}\end{matrix} ] , l ∈ \{ 0 , 1 , … R - 1 \}$$

$${P}_{l , t} = [ \begin{matrix}{\sum }_{s = 0}^{{S}_{l} - 1} {V}_{l , s , 1}^{5} {\sum }_{d = 0}^{{D}_{l} - 1} {β}_{l , s , d , 1} {g}_{l , t}^{d} \\ {\sum }_{s = 0}^{{S}_{l} - 1} {V}_{l , s , 2}^{5} {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{l , s \text{.1}}^{5} {\sum }_{d = 0}^{{D}_{l} - 1} {β}_{l , s , d , 1} {g}_{t}^{d} \\ {\sum }_{s = 0}^{{S}_{l} - 1} {V}_{l , s , 2}^{5} {\sum }_{d = 0}^{{D}_{l} - 1} {β}_{l , s , d , 2} {g}_{t}^{d}\end{matrix} ] , t ∈ \{ 0 , 1 , … , T - 1 \}$$

Among the nine example structures above, the last sixth structures are more suitable for two polarization directions and the first three structures can be suitable one or two polarization direction. Both

$${V}_{l , s , 1}^{5} and {V}_{l , s , 2}^{5}$$

are a fifth type of vector. They can be determined in a similar manner described above. The UE determines and reports the index of groups with a sub vector 0 for the

$${V}_{l , s , 1}^{5} and {V}_{l , s , 2}^{5}$$

respectively.

In some embodiments, β_{l,s} is a coefficient and

$${V}_{s}^{5}$$

is determined based on a similar manner for determining

$${V}_{l , s}^{5}$$

If Sₗ=1, the column is based on only one fifth type vector (e.g., the weighted vector can be one fifth type of vector). In some embodiments, if Sₗ=1 and β_{l,s}=1, one set of the fifth type of vectors of column l includes Sₗ vectors. In some implementation, different sets of the fifth type of vectors for different columns include different numbers of fifth type of vector. In some implementations, R sets of the fifth type of vector for R columns include the same number of fifth type of vectors (e.g., the subscript l can be ignored). The variable β_{l,s,d} is a weighted coefficient of the s^{th} fifth type of vector and d^{th} sixth type of vector (e.g., frequency domain vector) for layer l. The variable

$${g}_{t}^{d}$$

is the t^{th} elements or a sixth type of vector (e.g., frequency domain vector) that includes T elements. In some implementations,

$${g}_{t}^{d} = exp ( j 2 π \frac{t * {k}^{d}}{T} ) , {k}^{d} ∈ \{ 0 , 1 , … , T - 1 \} .$$

The variable

$${g}_{l , t}^{d}$$

is the t^{th} elements or one sixth type of vector (e.g., frequency domain vector) that includes T elements and corresponds to layer l. In some implementations,

$${g}_{l , t}^{d} = exp ( j 2 π \frac{t * {k}^{d}}{T} ) , {k}^{d} ∈ \{ 0 , 1 , … , T - 1 \} .$$

There are T frequency domain units. The number of frequency domain vectors Dₗ for different layers are different (e.g., Dₗ₁ and D^{l2} are different). In some implementations, the number of frequency domain vectors for at least two layers remains the same. In some implementations, the number of frequency domain vectors for all layers is the same (e.g., the subscript l of Dₗ can be ignored). The variable P_{l,t} is the column with an index l among the R columns of a precoding matrix on a frequency domain unit with index t, t∈{0, 1, . . . T−1}.

In some embodiments, the R columns share the same set of fifth type of vectors. Each of the column is a weighted vector of the same set of fifth type of vectors respectively. For example, the column with an index l among the R columns has one of the following structures:

$${P}_{l} = {\sum }_{s = 0}^{{S}_{l} - 1} {β}_{l , s , 1} {V}_{l , s}^{5} , l ∈ \{ 0 , 1 , … R - 1 \}$$

$${P}_{l , t} = {\sum }_{s = 0}^{{S}_{l} - 1} {V}_{s}^{5} {\sum }_{d = 0}^{{D}_{l} - 1} {β}_{l , s , d , 1} {g}_{l , t}^{d} , t ∈ \{ 0 , 1 , … , T - 1 \}$$

$${P}_{l , t} = {\sum }_{s = 0}^{{S}_{l} - 1} {V}_{s}^{5} {\sum }_{d = 0}^{{D}_{l} - 1} {β}_{l , s , d , 1} {g}_{t}^{d} , t ∈ \{ 0 , 1 , … , T - 1 \}$$

$${P}_{l} = [ \begin{matrix}{\sum }_{s = 0}^{{S}_{l} - 1} {β}_{l , s , 1} {V}_{l , s}^{5} \\ {\sum }_{s = 0}^{{S}_{l} - 1} {β}_{l , s , 2} {V}_{l , s}^{5}\end{matrix} ] , l ∈ \{ 0 , 1 , … R - 1 \}$$

$${P}_{l , t} = [ \begin{matrix}{\sum }_{s = 0}^{{S}_{l} - 1} {V}_{s}^{5} {\sum }_{d = 0}^{{D}_{l} - 1} {β}_{l , s , d , 1} {g}_{l , t}^{d} \\ {\sum }_{s = 0}^{{S}_{l} - 1} {V}_{s}^{5} {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{s}^{5} {\sum }_{d = 0}^{{D}_{l} - 1} {β}_{l , s , d , 1} {g}_{t}^{d} \\ {\sum }_{s = 0}^{{S}_{l} - 1} {V}_{s}^{5} {\sum }_{d = 0}^{{D}_{l} - 1} {β}_{l , s , d , 2} {g}_{t}^{d}\end{matrix} ] , t ∈ \{ 0 , 1 , … , T - 1 \}$$

$${P}_{l} = [ \begin{matrix}{\sum }_{s = 0}^{{S}_{l} - 1} {β}_{l , s , 1} {V}_{s , 1}^{5} \\ {\sum }_{s = 0}^{{S}_{l} - 1} {β}_{l , s , 2} {V}_{s , 2}^{5}\end{matrix} ] , l ∈ \{ 0 , 1 , … R - 1 \}$$

$${P}_{l , t} = [ \begin{matrix}{\sum }_{s = 0}^{{S}_{l} - 1} {V}_{s , 1}^{5} {\sum }_{d = 0}^{{D}_{l} - 1} {β}_{l , s , d , 1} {g}_{l , t}^{d} \\ {\sum }_{s = 0}^{{S}_{l} - 1} {V}_{s , 2}^{5} {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{s , 1}^{5} {\sum }_{d = 0}^{{D}_{l} - 1} {β}_{l , s , d , 1} {g}_{t}^{d} \\ {\sum }_{s = 0}^{{S}_{l} - 1} {V}_{s , 2}^{5} {\sum }_{d = 0}^{{D}_{l} - 1} {β}_{l , s , d , 2} {g}_{t}^{d}\end{matrix} ] , t ∈ \{ 0 , 1 , … , T - 1 \}$$

Among the nine structures above, the last sixth structures are more suitable for two polarization directions and the first three format can be suitable for one or two polarization directions. Both

$${V}_{s , 1}^{5} and {V}_{s , 2}^{5}$$

are vectors of the fifth type. They can be determined based on a similar manner to determine

$${V}_{s}^{5}$$

The UE determines and reports the indices of groups with zero elements (e.g., zero sub-vectors) for

$${V}_{s , 1}^{5} and {V}_{s , 2}^{5}$$

respectively. The S vectors

$${V}_{s}^{5}$$

comprise the same set of fifth type of vectors. The index of zero sub-vector of each of the S₁ fifth type of vector

$${V}_{{s}_{1}}^{5}$$

is determined by the UE respectively. The UE reports the index of a zero sub-vector for each of the S₁ fifth type of vector

$${V}_{{s}_{1}}^{5} .$$

The index of the zero sub-vector of each of the S₂ first type of vector

$${V}_{{s}_{1}}^{1}$$

is also determined by the UE respectively. The UE reports the index of a zero sub-vector for each of each of the S₂ first type of vector

$${V}_{{s}_{1}}^{1} .$$

In some embodiments, the R sets of fifth type of vector are based on R sets of third type of vectors and the R sets of first type of vector. The R sets of first type of vectors is based on a dot product of two vectors as described in Embodiment 1. The R sets of third type of vectors is also based on a dot product of two vectors as described in Embodiment 1, with one vector having all non-zero elements and the other vector having 0 or 1 elements. For example,

$${V}_{l , s}^{5} = ( {V}_{{s}_{1}}^{d} {V}_{l , {s}_{1}}^{c} ) ⊗ ( {V}_{{s}_{2}}^{b} {V}_{l , {s}_{2}}^{a} ) or {V}_{l , s , j}^{5} = ( {V}_{{s}_{1} , j}^{d} {V}_{l , {s}_{1} , j}^{c} ) ⊗ ( {V}_{{s}_{2} , j}^{b} {V}_{l , {s}_{2} , j}^{a} ) ,$$

$$j = 1 , 2.$$

Here, an index s of the fifth type of vector corresponds to one index s₁ of the third type of vector among the the S₁ third type of vectors and one index s₂ of the first type of vector among the S₂ first type of vectors. Variables

$${V}_{{s}_{2}}^{b} and {V}_{l , {s}_{2}}^{a}$$

are the two vectors for the dot product to obtain the first type of vector

$${V}_{{s}_{1}}^{c} and {V}_{l , {s}_{2}}^{d}$$

are the two vectors for the dot product to obtain the third type of vector. The column with an index l among the R columns can have one of the following structures:

$${P}_{l} = {\sum }_{s = 0}^{{S}_{l} - 1} {β}_{l , s} {V}_{l , s}^{5} , l ∈ \{ 0 , 1 , … R - 1 \}$$

$${P}_{l , t} = {\sum }_{s = 0}^{{S}_{l} - 1} {V}_{l , s}^{5} {\sum }_{d = 0}^{{D}_{l} - 1} {β}_{l , s , d} {g}_{l , t}^{d} , t ∈ \{ 0 , 1 , … , T - 1 \}$$

$${P}_{l , t} = {\sum }_{s = 0}^{{S}_{l} - 1} {V}_{l , s}^{5} {\sum }_{d = 0}^{{D}_{l} - 1} {β}_{l , s , d} {g}_{t}^{d} , t ∈ \{ 0 , 1 , … , T - 1 \}$$

$${P}_{l} = [ \begin{matrix}{\sum }_{s = 0}^{{S}_{l} - 1} {β}_{l , s , 1} {V}_{l , s}^{5} \\ {\sum }_{s = 0}^{{S}_{l} - 1} {β}_{l , s , 1} {V}_{l , s}^{5}\end{matrix} ] , l ∈ \{ 0 , 1 , … R - 1 \}$$

$${P}_{l , t} = [ \begin{matrix}{\sum }_{s = 0}^{{S}_{l} - 1} {V}_{l , s}^{5} {\sum }_{d = 0}^{{D}_{l} - 1} {β}_{l , s , d} {g}_{l , t}^{d} \\ {\sum }_{s = 0}^{{S}_{l} - 1} {V}_{l , s}^{5} {\sum }_{d = 0}^{{D}_{l} - 1} {β}_{l , s , d} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{l , s}^{5} {\sum }_{d = 0}^{{D}_{l} - 1} {β}_{l , s , d , 1} {g}_{t}^{d} \\ {\sum }_{s = 0}^{{S}_{l} - 1} {V}_{l , s}^{5} {\sum }_{d = 0}^{{D}_{l} - 1} {β}_{l , s , d , 2} {g}_{t}^{d}\end{matrix} ] , t ∈ \{ 0 , 1 , … , T - 1 \}$$

$${P}_{l} = [ \begin{matrix}{\sum }_{s = 0}^{{S}_{l} - 1} {β}_{l , s , 1} {V}_{l , s , 1}^{5} \\ {\sum }_{s = 0}^{{S}_{l} - 1} {β}_{l , s , 1} {V}_{l , s , 2}^{5}\end{matrix} ] , l ∈ \{ 0 , 1 , … R - 1 \}$$

$${P}_{l , t} = [ \begin{matrix}{\sum }_{s = 0}^{{S}_{l} - 1} {V}_{l , s , 1}^{5} {\sum }_{d = 0}^{{D}_{l} - 1} {β}_{l , s , d , 1} {g}_{l , t}^{d} \\ {\sum }_{s = 0}^{{S}_{l} - 1} {V}_{l , s , 2}^{5} {\sum }_{d = 0}^{{D}_{l} - 1} {β}_{l , s , d , 2} {g}_{l , t}^{d}\end{matrix} ] , t ∈ \{ 0 , 1 , … , T - 1 \}$$

$${P}_{l , t} = [ \begin{matrix}{\sum }_{s = 0}^{{S}_{l} - 1} {V}_{l , s , 1}^{5} {\sum }_{d = 0}^{{D}_{l} - 1} {β}_{l , s , d , 1} {g}_{t}^{d} \\ {\sum }_{s = 0}^{{S}_{l} - 1} {V}_{l , s \text{.2}}^{5} {\sum }_{d = 0}^{{D}_{l} - 1} {β}_{l , s , d , 2} {g}_{t}^{d}\end{matrix} ] , t ∈ \{ 0 , 1 , … , T - 1 \}$$

Among the nine structures above, the last sixth formats are more suitable for two polarization directions and the first three format can be suitable for one or two polarization directions. In some implementations, the UE determines that all elements of the first type of vector are non-zero. The UE only reports the group index with a zero sub-vector for each of the third type of vectors or for each set of the fifth type of vectors.

In above implementation, the two half elements of P_{l,t} correspond to same set of frequency domain vectors, such as

$${g}_{t}^{d} or {g}_{l , t}^{d} .$$

In some implementation, the two half elements of P_{l,t} correspond to different sets of frequency domain vectors. For example, for the first half elements of P_{l,t}, gₜ^{d} and

$${g}_{l , t}^{d}$$

are replaced with

$${g}_{t , 1}^{d} and {g}_{l , t , 1}^{d}$$

respectively. For the second half elements of P_{l,t},

$${g}_{t}^{d} and {g}_{l , t}^{d}$$

are replaced with

$${g}_{t , 2}^{d} and {g}_{l , t , 2}^{d}$$

respectively.

This embodiment includes usage of the third type of vectors, which have with similar characteristics as compared to the first type of vectors except that their numbers of elements may be different. The first type of vectors and the third type of vectors can correspond to spatial domain vector of different dimensions.

### Embodiment 3

This embodiment focuses on the indication of the precoding matrix based on the reference signal resources. In some embodiments, the UE is configured with Y reference signal resources, such as Channel State Information Reference Signal (CSI-RS) resources. Each of the Y reference signal resources includes one or more antenna ports. The UE determines one or more reference signal resources from the Y reference signal resources for each layer. The precoding vector for each layer is based on the corresponding one or more reference signal resources for the layer. Each precoding vector for each layer corresponds to a respective number of the selected reference signal.

For example, the UE is configured with 4 CSI-RS resources, each of which corresponds to Nᵢ, i=0,1,2,3 CSI-RS antenna ports. In some implementations, Nᵢ=16. The UE selects CSI-RS resource 0 for first layer. The UE selects CSI-RS resource 0,2,3 for the second layer. The UE selects CSI-RS resource 3 for the third layer. The UE reports the selected CSI-RS resource indexes for each layer. For example, the UE reports index 0 of CSI-RS resource for the first layer, index 0,2,3 of CSI-RS resource for the second layer, and index 3 of CSI-RS resource for the third layer. In some implementations, the UE reports the selected CSI-RS resource indexes for each layer group, where layers in one layer group correspond to same selected CSI-RS resource index/indices.

The precoding vector for each layer is based on the selected CSI-RS resource(s). For example, the precoding vector of first layer has following structure: P_{0,N}_{₀}_{*1}, where P_{0,N}_{₀}_{*1} is a vector that includes No elements each of which corresponding to one antenna port of CSI-RS resource 0. As another example, the precoding vector of second layer has the following structure: P_{1,(N}_{₀}_{+N}_{₂}_{+N}_{₃}_{)*1}, where P_{1,(N}_{₀}_{+N}_{₂}_{+N}_{ₐ}_{)*1} is a vector that includes N₀+N₂+N₃ elements each of which corresponding to one antenna port of one of CSI-RS resource 0, 2, or 3. Yet as another example, the precoding vector of third layer has following structure: P_{2,N}_{₃}_{*1}, wherein P_{2,N}_{₃}_{*1} is a vector that includes N₃ elements each of which corresponding to one antenna port of CSI-RS resource 3. Nᵢ, i=0, 1, 2, 3 is the number of antenna ports of CSI-RS resource i among the Y CSI-RS resources. The number of elements of one precoding vector for one layer is equal to the sum of the number of antenna ports of the selected one or more CSI-RS resources for the one layer. Each element of the precoding vector for a layer corresponds to one antenna port of the selected CSI-RS resources. Different precoding vectors for different layers can include different number of elements.

In some implementations, each precoding vector of one layer includes one or more groups of elements. Each group of elements can be the first sub vector. That is each precoding vector of one layer includes one or more first sub vectors. Each group of elements is based on a set of second sub vectors corresponding to one selected CSI-RS resource. For each layer, the UE reports the number of sub-vectors for each set of sub-vectors. For example, the precoding vector of the second layer is based on selected CSI-RS resource 0, 2 and 3. The precoding vector includes three groups of elements. Each group of the three groups of elements corresponds to one of the selected CSI-RS resources 0, 2, 3. For example, the group of elements corresponds to selected CSI-RS resource j of the precoding vector of the second layer has following structure:

$${P}_{1 , j} = {\sum }_{s = 0}^{{S}_{1 , j} - 1} {α}_{1 , j , s} {W}_{1 , j , s} , j = 0 , 2 , 3$$

The precoding vector of the second layer has following structure:

$${P}_{1} = [ \begin{matrix}{P}_{1 , 0} \\ {P}_{1 , 2} \\ {P}_{1 , 3}\end{matrix} ]$$

For each layer, the precoding vector of the layer has following structure:

$${P}_{l} = [ \begin{matrix}{P}_{1 , {j}_{0}} \\ {P}_{1 , {j}_{1}} \\ {P}_{1 , {j}_{{f}_{l} - 1}}\end{matrix} ]$$

Here, j₀, j₁, . . . , j_{f}_{ₗ}₋₁ is the selected CSI-RS resources among the Y CSI-RS resources. The variable fₗ is the number of selected CSI-RS resources for the layer. The UE reports S_{l,j}, the number of sub vectors for each selected CSI-RS resource for each layer.

The Y CSI-RS resource can be replaced with Y CSI-RS port groups of one CSI-RS resource. Then one CSI-RS resource can be replaced with one of the Y CSI-RS port groups of one CSI-RS resource.

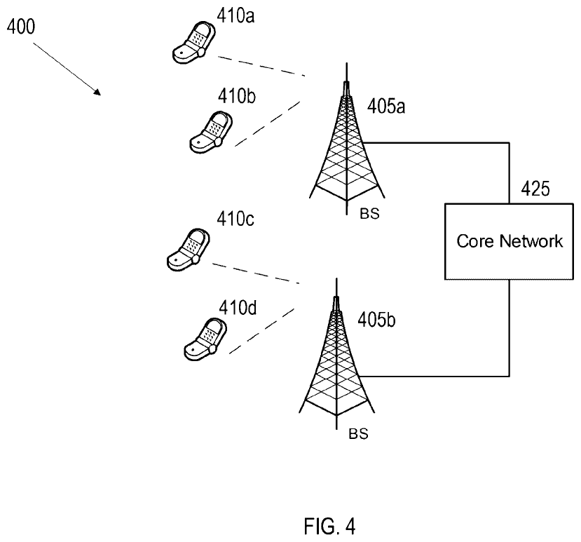

FIG. 4 shows an example of a wireless communication system 400 where techniques in accordance with one or more embodiments of the present technology can be applied. A wireless communication system 400 can include one or more base stations (BSs) 405a, 405b, one or more wireless devices (or UEs) 410a, 410b, 410c, 410d, and a core network 425. A base station 405a, 405b can provide wireless service to user devices 410a, 410b, 410c and 410d in one or more wireless sectors. In some implementations, a base station 405a, 405b includes directional antennas to produce two or more directional beams to provide wireless coverage in different sectors. The core network 425 can communicate with one or more base stations 405a, 405b. The core network 425 provides connectivity with other wireless communication systems and wired communication systems. The core network may include one or more service subscription databases to store information related to the subscribed user devices 410a, 410b, 410c, and 410d. A first base station 405a can provide wireless service based on a first radio access technology, whereas a second base station 405b can provide wireless service based on a second radio access technology. The base stations 405a and 405b may be co-located or may be separately installed in the field according to the deployment scenario. The user devices 410a, 410b, 410c, and 410d can support multiple different radio access technologies. The techniques and embodiments described in the present document may be implemented by the base stations or wireless devices described in the present document.

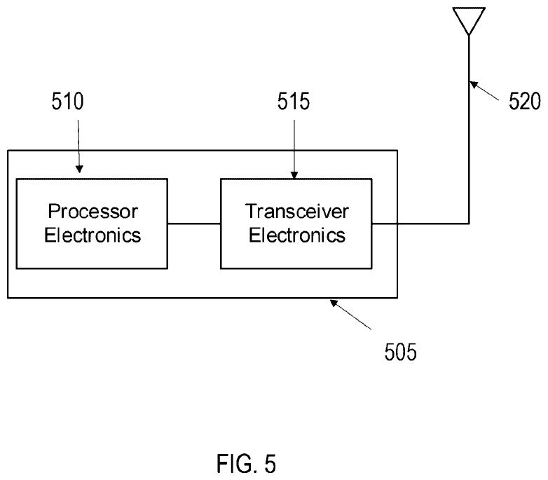

FIG. 5 is a block diagram representation of a portion of a radio station in accordance with one or more embodiments of the present technology can be applied. A radio station 505 such as a network node, a base station, or a wireless device (or a user device, UE) can include processor electronics 510 such as a microprocessor that implements one or more of the wireless techniques presented in this document. The radio station 505 can include transceiver electronics 515 to send and/or receive wireless signals over one or more communication interfaces such as antenna 520. The radio station 505 can include other communication interfaces for transmitting and receiving data. Radio station 505 can include one or more memories (not explicitly shown) configured to store information such as data and/or instructions. In some implementations, the processor electronics 510 can include at least a portion of the transceiver electronics 515. In some embodiments, at least some of the disclosed techniques, modules or functions are implemented using the radio station 505. In some embodiments, the radio station 505 may be configured to perform the methods described herein.

It is thus appreciated that the disclosed techniques are especially suitable for scenarios in which signals from part of the antenna ports are not received by the receiving device due to blockage. The disclosed techniques consider the fact that the distribution(s) of the blocked antenna ports may be different for different paths/scattering paths. Implementations of the disclosed techniques can help ensure that the reported precoding matrix matches the channel conditions to improve spectrum efficiency and reduce communication latency with minimal reporting overhead.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method for wireless communication, comprising:
receiving, by a receiving device, a reference signal from a transmitting device;
determining, by the receiving device, a precoding matrix based on the reference signal, wherein a structure of the precoding matrix is based on one or more vectors, wherein the precoding matrix includes R columns, wherein a column of the precoding matrix is based on a weighted sum of a set of vectors corresponding to the column, wherein the set of vectors corresponding to the column includes partial or all of the one or more vectors; or one or two of the one or more vectors corresponds to one of R columns of the precoding matrix, R is equal to or greater than 1; and
transmitting, by the receiving device, information about the precoding matrix to the transmitting device,
wherein one or more elements in a vector of the one or more vectors are zero.

2-3. (canceled)

4. The method of claim 1, wherein the information indicates that the one or more elements in a vector of the one or more vectors are zero; or the information indicates which element of a vector of the one or more vectors are non-zero.

5-7. (canceled)

8. The method of claim 1, wherein each vector of the one or more vectors is represented based on a dot product of a first vector and a second vector, wherein the first vector comprises non-zero elements only, and wherein the second vector comprises elements that are 0 or 1.

9. The method of any of claim 1, wherein each vector of the one or more vectors comprises multiple sub-vectors, and wherein the information indicates that one or more of the multiple sub-vectors include zero elements.

10-11. (canceled)

12. The method of claim 9, wherein the one or more vectors are organized into L sets of vectors, and
wherein for each of the L sets of vectors, the information comprises:
an index of a zero sub-vector in the multiple sub-vectors, or indication information for indicating that one or more of the multiple sub-vectors include zero elements,
wherein all elements of the zero sub-vector being zero, and wherein L is equal to 1 or larger than 1.

13. The method of claim 12, wherein the L sets of vectors corresponds to R columns of the precoding matrix, and each of the R columns corresponding to one or two of the L sets of vectors, wherein L equals to R or 2×R.

14. (canceled)

15. The method of any of claim 1, wherein each vector of the one or more vectors comprises multiple sub-vectors and the information indicates a first coefficient of one of the multiple sub-vectors of a vector of the one or more vectors.

16. The method of claim 15, wherein, for each of the one or more vectors, the information includes a parameter shared by the multiple sub-vectors, and at least one of the following is satisfied:
the parameter includes at least one of: a second coefficient shared by the multiple sub-vectors, or an index of each vector among multiple predefined vectors; or
the information indicates a respective first coefficient for each of the multiple sub-vectors of a vector of the one or more vectors.

17-21. (canceled)

22. The method of claim 9, wherein, in response to a first sub-vector comprising zero elements, elements in a second sub-vector that is adjacent to the first sub-vector are determined to be zero; or
wherein a first half of the multiple sub-vectors corresponds to antenna ports in a first direction and a second half of the multiple sub-vectors corresponds to antenna ports in a second direction, and wherein, in response to a first sub-vector in the first half comprising zero elements, elements of a second sub-vector in the second half are determined to be zero, wherein the second sub-vector is associated with the first sub-vector.

23-25. (canceled)

26. The method of claim 1, wherein each column of the precoding matrix and each of the one or more vectors have a same number of elements; or
a number of elements in a column of the precoding matrix is twice the number of elements in each of the one or more vectors.

27. (canceled)

28. The method of claim 1, wherein the one or more vectors form a first group of vectors, wherein the structure of the precoding matrix is further based on one or more additional vectors that form a second group of vectors, and wherein the information indicates that selected elements in a vector of the one or more additional vectors are zero, wherein
the first group of vectors corresponds to a first dimension of antenna ports of the reference signal and the second group of vectors corresponds to a second dimension of antenna ports of the reference signal;
the precoding matrix is based on a Kronecker product of a vector from the first group of vectors and a vector from the second group of vectors.

29-32. (canceled)

33. The method of claim 1, wherein the information comprises one or more indices of one or more selected reference signal resources for each layer or each group of layers respectively.

34. The method of claim 1, wherein at least one of following is satisfied:
a number of elements of a vector for the corresponding layer or the group of layers is equal to a sum or half a sum of antenna ports of the one or more selected reference signal resources;
different columns of the precoding matrix for different layers include different numbers of elements; or
a vector of the one or more vectors comprises multiple first sub-vectors, each sub-vector of the multiple first sub-vectors corresponding to one of the one or more selected reference signal resources.

35-36. (canceled)

37. The method of claim 34, wherein the information indicates, for each layer or layer groups, a set of second sub-vectors corresponding to one of the multiple first sub-vectors, wherein a number of elements included in a first sub-vector equals to a number of elements included in a second sub-vector corresponding to the first sub-vector.

38. The method of claim 37, wherein at least one of the following is satisfied:
the information indicates a number of second sub-vectors included in the set of second sub-vectors corresponding to one of the multiple first sub-vectors; or
a first sub vector is a weighted sum of the set of second sub-vectors.

39. (canceled)

40. A communication apparatus, comprising a processor configured to;
receive a reference signal from a transmitting device;
determine a precoding matrix based on the reference signal, wherein a structure of the precoding matrix is based on one or more vectors, wherein the precoding matrix includes R columns, wherein a column of the precoding matrix is based on a weighted sum of a set of vectors corresponding to the column, wherein the set of vectors corresponding to the column includes partial or all of the one or more vectors; or one or two of the one or more vectors corresponds to one of R columns of the precoding matrix, R is equal to or greater than 1; and
transmit information about the precoding matrix to the transmitting device,
wherein one or more elements in a vector of the one or more vectors are zero.

41. (canceled)

42. A method for wireless communication, comprising:
transmitting, by a transmitting device, a reference signal to a receiving device; and
receiving, by the transmitting device from the receiving device, information about a precoding matrix corresponding to the reference signal, wherein a structure of the precoding matrix is based on one or more vectors,
wherein the precoding matrix includes R columns, wherein a column of the precoding matrix is based on a weighted sum of a set of vectors corresponding to the column, wherein the set of vectors corresponding to the column includes partial or all of the one or more vectors; or one or two of the one or more vectors corresponds to one of R columns of the precoding matrix, R is equal to or greater than 1; and
one or more elements in a vector of the one or more vectors are zero.

43. The method of claim 42, wherein the information comprises one or more indices of one or more selected reference signal resources for each layer or each group of layers respectively.

44. The apparatus of claim 40, wherein the information comprises one or more indices of one or more selected reference signal resources for each layer or each group of layers respectively.

45. The apparatus of claim 40, wherein each vector of the one or more vectors comprises multiple sub-vectors, and wherein the information indicates that one or more of the multiple sub-vectors include zero elements;
wherein the one or more vectors are organized into L sets of vectors, and
wherein for each of the L sets of vectors, the information comprises:
an index of a zero sub-vector in the multiple sub-vectors, or indication information for indicating that one or more of the multiple sub-vectors include zero elements,
wherein all elements of the zero sub-vector being zero, and wherein L is equal to 1 or larger than 1.
